(19) United States
(12) Patent Application Publication
(10) Pub. No.: US 2014/0329176 A1
(43) Pub. Date: Nov. 6, 2014

(54) TONER AND IMAGE FORMING METHOD

(71) Applicant: CANON KABUSHIKI KAISHA, Tokyo (JP)

(72) Inventors: Ichiro Kanno, Abiko-shi (JP); Nozomu Komatsu, Toride-shi (JP); Takakuni Kobori, Toride-shi (JP); Takeshi Hashimoto, Moriya-shi (JP); Yosuke Iwasaki, Abiko-shi (JP); Hiroyuki Fujikawa, Yokohama-shi (JP); Hideki Kaneko, Yokohama-shi (JP)

(73) Assignee: CANON KABUSHIKI KAISHA, Tokyo (JP)

(21) Appl. No.: 14/261,140

(22) Filed: Apr. 24, 2014

(30) Foreign Application Priority Data
May 1, 2013 (JP) 2013-096481

(51) Int. Cl. G03G 9/08

(52) U.S. Cl. CPC G03G 9/0825
USPC 430/108.7

(57) ABSTRACT

Provided is a toner that allows a transferred image to be stably output regardless of smoothness of a transfer material even under high-temperature and high-humidity environment or under low-temperature and low-humidity environment, that is excellent in cleanability for a transfer member even at the time of high-speed printing, and that causes less member contamination. The toner is a toner including toner particles each containing a binder resin and a wax, and silica fine particles on surfaces of the toner particles, wherein the silica fine particles have a number-average particle diameter of primary particles of 60 nm or more and 300 nm or less, a coverage rate of the surfaces of the toner particles with the silica fine particles is 15% or more and 95% or less, and the toner has a uniaxial collapse stress at a maximum consolidation stress of 10.0 kPa, of 2.5 kPa or more and 3.5 kPa or less.

### BACKGROUND OF THE INVENTION

1. Field of the Invention

The present invention relates to a toner and an image forming method for use in an electrophotographic system, an electrostatic recording system, an electrostatic printing system or a toner jet system.

2. Description of the Related Art

In recent years, a full-color image forming apparatus such as a full-color printer or a full-color copier has been required to deal with not only plain paper but also various materials such as recycled paper having large surface irregularities. Therefore, a transfer method using an intermediate transfer member is being mainly adopted.

In the transfer method using an intermediate transfer member, it is usually necessary to transfer a toner image visualized, from an image bearing member to the intermediate transfer member, and then further transfer the image from the intermediate transfer member to a transfer material again. Since the number of transfer operations is increased as compared with a conventional method, concerns are the reduction in dot reproducibility (asperity) and the decrease in transfer efficiency, which cause the deterioration in image quality. Furthermore, while a mechanism for scraping a toner remaining on the intermediate transfer member by a regulating member such as a blade for the purpose of cleaning is usually provided, passing-through of the remaining toner and the like occur at the time of high-speed printing or the like, causing the remaining toner to be retained on the intermediate transfer member over a long period. Therefore, toner contamination and the like may be caused.

Then, studies have been recently made in which various fine particles are externally added to a surface of the toner as one procedure for enhancing transferability and contamination resistance of a transfer member.

For example, in Japanese Patent Application Laid-Open No. 2012-133338, a toner has been proposed in which an external additive having an average primary particle diameter of 80 nm or more and 150 nm or less with a specified distribution is attached to toner particles to improve the dot reproducibility. In the proposition, however, no studies have been made about the state where the external additive is attached to a surface of the toner. At the time of high-speed printing, the reduction in transfer efficiency may be caused in some toner that is less covered with the external additive, having an influence on image uniformity and the like. Furthermore, when a material having large irregularities, such as recycled paper, is used as a transfer material, the degree of the influence is increased.

In addition, in Japanese Patent No. 4944980, a toner has been proposed in which mixed fine particles of small-particle diameter fine particles having a volume average particle diameter of 5 nm or more and less than 80 nm and large-particle diameter fine particles having a volume average particle diameter of 80 nm or more and less than 200 nm are externally added. In the proposition, an adhesive force between toners is decreased to thereby attempt the reduction in the number of “voids” that are one transfer failure in which only a central portion such as a fine line is not transferred. However, cleanability on the intermediate transfer member is likely to be insufficient at the time of high-speed printing, easily causing a problem such as shortening in lifetime of a member due to member contamination and the like. In order to solve the problem, there is a demand for a further improved toner.

### SUMMARY OF THE INVENTION

An object of the present invention is to provide a toner and an image forming method that have solved the above problem, that do not impair transferability even at the time of high-speed printing in which a transfer material having large irregularities, such as recycled paper, is used, that do not cause member contamination even over long-term use, and that enable stably output of an image.

The above problem can be solved by a toner and an image forming method each having the following configuration.

That is, the present invention relates to a toner including toner particles each containing a binder resin and a wax, and silica fine particles on surfaces of the toner particles, in which the silica fine particles have a number-average particle diameter of primary particles of 60 nm or more and 300 nm or less, a coverage rate of the surfaces of the toner particles with the silica fine particles is 15% or more and 95% or less, and the toner has a uniaxial collapse stress at a maximum consolidation stress of 10.0 kPa, of 2.5 kPa or more and 3.5 kPa or less.

Further, the present invention relates to an image forming method including charging a surface of a photosensitive member, forming an electrostatic latent image on the photosensitive member by light exposure, developing the electrostatic latent image by a toner to form a toner image, primarily transferring the toner image to an intermediate transfer member and then secondarily transferring the toner image on the intermediate transfer member to a transfer material, and removing a transfer residue toner remaining on the intermediate transfer member after the primary transferring, from the intermediate transfer member by a cleaning member, in which the above-described toner is used.

The present invention can provide a toner and an image forming method that allow a transferred image to be stably output regardless of smoothness of a transfer material even under a high-temperature and high-humidity environment or under a low-temperature and low-humidity environment, that are excellent in cleanability for a transfer member even at the time of high-speed printing, and that cause less member contamination.

Further features of the present invention will become apparent from the following description of exemplary embodiments with respect to the attached drawings.

### BRIEF DESCRIPTION OF THE DRAWINGS

FIG. 1 illustrates a view of a heat spheroidizing treatment apparatus.

FIG. 2 illustrates a schematic configuration of an image forming apparatus.

FIG. 3 illustrates a schematic configuration of an intermediate transfer belt cleaning apparatus.

### DESCRIPTION OF THE EMBODIMENTS

Now, an embodiment for carrying out the present invention is described in detail.

The toner of the present invention is a toner including toner particles each containing a binder resin and a wax, and silica fine particles on surfaces of the toner particles, in which the silica fine particles have a number-average particle diameter of primary particles of 60 nm or more and 300 nm or less, a coverage rate of the surfaces of the toner particles with the silica fine particles is 15% or more and 95% or less, and the toner has a uniaxial collapse stress at a maximum consolidation stress of 10.0 kPa, of 2.5 kPa or more and 3.5 kPa or less.

As a result of their extensive studies, the inventors of the present invention have found that a surface of the toner is covered with silica fine particles in a specified range and a uniaxial collapse stress in a consolidation state is controlled in a specified range, thereby resulting in good transferring from a transfer member to a recording medium. It has been thus found that an image high in in-plane uniformity can be obtained and a stable image density can be achieved over a long period. Although a mechanism for the foregoing is unknown, the inventors of the present invention consider the mechanism to be as described below.

When a toner is primarily transferred to an intermediate transfer member, the toner is pressed to the intermediate transfer member under high pressure to be in the consolidation state. Thereafter, during secondary transferring to a recording medium, when an adhesive force between the toners in the consolidation state is high and an adhesive force between the intermediate transfer member and the toner is low, a consolidated toner lump is easily detached from the transfer member without being internally broken, and therefore less toner remains on the transfer member.

In other words, a toner having a controlled uniaxial collapse stress under a certain pressure can be used to thereby result in the increase in adhesive force between the toners in the consolidation state, suppressing internal collapse. Additionally, the coverage rate of the surfaces of the toner particles with the silica fine particles can be controlled in the above range to thereby weaken the adhesive force between the intermediate transfer member and the toner, achieving good transferability. In addition, the inventors of the present invention consider that such an effect can be exerted regardless of the smoothing property of the transfer material. The degree of the smoothing property of the transfer material is adjusted by the surface property, the pressing force and the speed of a roller, and the like, and is expressed by the Bekk smoothness or the like.

The inventors of the present invention also consider that when the above configuration is adopted, an adhesive force between toner particles is similarly increased in the state of consolidation between the surface of the intermediate transfer member and a scraping blade even in a cleaning step of the intermediate transfer member by a scraping member such as a blade, and on the other hand, the adhesive force between the transfer member and the toner is decreased, thereby allowing recovery of the remaining toner to be smoothly performed to exert effects of suppressing cleaning failures such as passing-through, and member contamination.

The toner of the present invention is a toner

i) including toner particles each containing a binder resin and a wax, and silica fine particles on surfaces of the toner particles,
ii) the silica fine particles have a number-average particle diameter of primary particles of 60 nm or more and 300 nm or less, and
iii) a coverage rate of surfaces of the toner particles with the silica fine particles is 15% or more and 95% or less (preferably 20% or more and 95% or less).

When the number-average particle diameter of primary particles of the silica fine particles is less than nm, irregularities on the surface of the toner are decreased to result in the increase in attachability between the toner and the member causing an adverse effect on transferability and transfer cleaning. In addition, when the number-average particle diameter of primary particles is more than 300 nm, the dispersion of the silica fine particles on the surface of the toner is likely to be nonuniform, a satisfactory coverage rate cannot be achieved, and the displacement of the adhesive force between the toners is generated to easily cause image unevenness.

In addition, when the coverage rate with the silica fine particles is less than 15%, the adhesive force between the toner and the member is increased and the balance at the time of transferring is lowered, easily causing transfer failures.

In addition, the toner of the present invention has a uniaxial collapse stress at a maximum consolidation stress of 10.0 kPa, of 2.5 kPa or more and 3.5 kPa or less.

When the uniaxial collapse stress is less than 2.5 kPa, the adhesive force between the toners is reduced and a toner lump is collapsed in the consolidation state at the time of transferring, easily causing image disorder. In addition, when the uniaxial collapse stress is more than 3.5 kPa, reproduction of fine spots, such as reproduction of fine lines, is difficult.

In addition, in the present invention, the toner preferably has the sticking ratio of the silica fine particles of 80% by mass or more with respect to the total amount of the silica fine particles. When the ratio is 80 mass % or more, detachment of the silica fine particles from the surface of the toner is favorably suppressed even after long-term use, and better transferability is achieved.

In order that the uniaxial collapse stress of the toner at the time of consolidation may be set to fall within the range specified in the present invention while the coverage rate with the silica fine particles is set to be relatively large like the present invention, such a method as described below can be given: for example, a polymer having a structure in which a vinyl-based resin component and a hydrocarbon compound react with each other is incorporated into each toner particle, and the silica fine particles are stuck to the surfaces of the toner particles by hot air treatment.

The incorporation of the polymer into the toner can improve the dispersibility of the wax in the toner, and can increase the speed at which the wax moves to the surface of each toner particle at the time of the hot air treatment. As a result, the wax is unevenly distributed between the silica fine particles stuck to the surfaces of the toner particles and the polymer, providing a toner having the above characteristics.

[Resin]

The binder resin for use in the toner of the present invention is not particularly limited, and any of the following polymers or resins can be used.

There may be used, for example: homopolymers of styrene and substituted products thereof such as polystyrene, poly-p-chlorostyrene and polyvinyl toluene; styrene-based copolymers such as a styrene-p-chlorostyrene copolymer, a styrene-vinyl toluene copolymer, a styrene-vinyl naphthalene copolymer, a styrene-acrylate copolymer, a styrene-methacrylate copolymer, a styrene-α-methyl chloromethacrylate copolymer, a styrene-acrylonitrile copolymer, a styrene-vinyl methyl ether copolymer, a styrene-vinyl ethyl ether copolymer, a styrene-vinyl methyl ketone copolymer and a styrene-acrylonitrile-indene copolymer; and polyvinyl chloride, a phenol resin, a natural resin-modified phenol resin, a natural resin-modified maleic acid resin, an acrylic resin, a methacrylic resin, polyvinyl acetate, a silicone resin, a polyester resin, polyurethane, a polyamide resin, a furan resin, an epoxy resin, a xylene resin, polyvinyl butyral, a terpene resin, a coumarone-indene resin and a petroleum-based resin.

Among the polymers and resins, a polyester resin is preferably used from the viewpoints of low-temperature fixability and chargeability control.

The polyester resin to be preferably used in the present invention is a resin having a “polyester unit” in its binder resin chain, and specific examples of a component forming the polyester unit include a dihydric or higher alcohol monomer component, and an acid monomer component such as a divalent or higher carboxylic acid, a divalent or higher carboxylic anhydride and a divalent or higher carboxylic acid ester.

Examples of the dihydric or higher alcohol monomer component include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, and ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane and 1,3,5-trihydroxymethylbenzene.

Among the monomers, an aromatic diol is preferably used as the alcohol monomer component. In the alcohol monomer component forming the polyester resin, the aromatic diol is preferably contained at a ratio of 80% by mol or more.

On the other hand, the acid monomer component such as a divalent or higher carboxylic acid, a divalent or higher carboxylic anhydride and a divalent or higher carboxylic acid ester include: aromatic dicarboxylic acids such as phthalic acid, isophthalic acid and terephthalic acid or anhydrides thereof; alkyl dicarboxylic acids such as succinic acid, adipic acid, sebacic acid and azelaic acid or anhydrides thereof; succinic acids substituted with an alkyl group or alkenyl group having 6 to 18 carbon atoms or anhydrides thereof; and unsaturated dicarboxylic acids such as fumaric acid, maleic acid and citraconic acid or anhydrides thereof.

Of those, a polyhydric carboxylic acid such as terephthalic acid, succinic acid, adipic acid, fumaric acid, trimellitic acid, pyromellitic acid, benzophenonetetracarboxylic acid, or an anhydride thereof is preferably used as the acid monomer component.

In addition, the acid value of the polyester resin is preferably 1 mg KOH/g or more and 20 mg KOH/g or less from the viewpoint of stability of the triboelectric charge quantity.

It should be noted that the acid value can be set within the above range by adjusting the type and the blending amount of the monomer to be used in the resin. Specifically, the acid value can be controlled by adjusting the alcohol monomer component ratio or acid monomer component ratio at the time of resin production, and the molecular weight. In addition, the acid value can be controlled by allowing a terminal alcohol to react with a polyacid monomer (for example, trimellitic acid) after ester condensation polymerization.

The toner of the present invention preferably contains, in the toner particles thereof, a polymer having a structure in which a vinyl-based resin component and a hydrocarbon compound react with each other, from the viewpoint of improving the dispersibility of the wax in the toner particles. In addition, the toner particles containing such a polymer can be subjected to a hot air treatment to thereby control the state of the wax present in the toner particles.

The polymer having a structure in which a vinyl-based resin component and a hydrocarbon compound react with each other can be particularly preferably a graft polymer having a vinyl-based resin component as a main chain and having a polyolefin as a side chain, or a graft polymer having a polyolefin as a main chain and having a vinyl-based resin component as a side chain.

The polymer having a structure in which a vinyl-based resin component and a hydrocarbon compound react with each other serves as a surfactant to the binder resin and the wax that have melted in a kneading step and a surface-smoothing step at the time of toner production. Accordingly, the polymer is preferred because the primary average dispersion particle diameter of the wax in the toner particles can be controlled and the speed of the wax migration to the surface of the toner in a surface treatment with hot air if necessary can be controlled.

The polyolefin that can be used to provide the graft polymer is not particularly limited as long as the polyolefin is a polymer or a copolymer of an unsaturated hydrocarbon-based monomer having one double bond, and various polyolefins can be used. In particular, polyethylenes and polypropylenes are each particularly preferably used.

On the other hand, the vinyl-based monomer that can be used to provide the vinyl-based resin component in the graft polymer includes the following.

Styrene-based monomers, for example, styrenes and derivatives thereof, such as styrene, o-methylstyrene, m-methylstyrene, p-methylstyrene, p-methoxystyrene, phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene.

Nitrogen atom-containing vinyl-based monomers such as: amino group-containing α-methylene aliphatic monocarboxylic acid esters such as dimethylaminoethyl methacrylate and diethylaminoethyl methacrylate; and acrylic acid or methacrylic acid derivatives, such as acrylonitrile, methacrylonitrile and acrylamide.

Carboxyl group-containing vinyl-based monomers such as: unsaturated dibasic acids such as maleic acid, citraconic acid, itaconic acid, alkenyl succinic acid, fumaric acid and mesaconic acid; unsaturated dibasic acid anhydrides such as maleic anhydride, citraconic anhydride, itaconic anhydride and alkenyl succinic anhydride; unsaturated dibasic acid half esters such as methyl maleate half ester, ethyl maleate half ester, butyl maleate half ester, methyl citraconate half ester, ethyl citraconate half ester, butyl citraconate half ester, methyl itaconate half ester, methyl alkenyl-succinate half ester, methyl fumarate half ester and methyl mesaconate half ester; unsaturated dibasic acid esters such as dimethylmaleic acid and dimethylfumaric acid; α,β-unsaturated acids such as acrylic acid, methacrylic acid, crotonic acid and cinnamic acid; α,β-unsaturated acid anhydrides such as crotonic anhydride and cinnamic anhydride, and anhydride of the α,β-unsaturated acid and a lower fatty acid; and monomers having a carboxyl group such as alkenyl malonic acid, alkenyl glutaric acid, and alkenyl adipic acid, and anhydrides thereof and monoesters thereof.

Hydroxyl group-containing vinyl-based monomers such as: acrylic acid esters and methacrylic acid esters such as 2-hydroxyethyl acrylate, 2-hydroxyethyl methacrylate and 2-hydroxypropyl methacrylate, and 4-(1-hydroxy-1-methylbutyl)styrene and 4-(1-hydroxy-1-methylhexyl)styrene.

Ester units formed of acrylates such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate and phenyl acrylate.

Ester units formed of methacrylates including α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate.

The polymer having a structure in which a vinyl-based resin component and a hydrocarbon compound react with each other can be obtained by a known method such as a reaction between the above-described monomers, and a reaction of the monomer of one polymer with the other polymer.

The constituent unit of the vinyl-based resin component can preferably include a styrene-based unit, and also acrylonitrile or methacrylonitrile.

The mass ratio of the hydrocarbon compound to the vinyl-based resin component in the polymer (hydrocarbon compound/vinyl-based resin component) is preferably 1/99 to 75/25. The hydrocarbon compound and the vinyl-based resin component are preferably used in the above range because the wax is dispersed in the toner particles and the speed of the wax migration to the surface of the toner can be controlled in a surface treatment with hot air if necessary.

The content of the polymer having a structure in which a vinyl-based resin component and a hydrocarbon compound react with each other is preferably 0.2 parts by mass or more and 20 parts by mass or less with respect to 100 parts by mass of the binder resin.

The polymer is preferably used in the above range because the wax is dispersed in the toner particles and the speed of the wax migration to the surface of the toner can be controlled in a surface treatment with hot air.

[Wax]

The wax for use in the toner of the present invention is not particularly limited, but includes the following: hydrocarbon-based waxes such as low molecular weight polyethylene, low molecular weight polypropylene, an alkylene copolymer, a microcrystalline wax, a paraffin wax and a Fischer-Tropsch wax; oxides of a hydrocarbon-based wax such as an oxidized polyethylene wax or block copolymerization products thereof; waxes containing a fatty acid ester as a main component, such as a carnauba wax; and waxes obtained by subjecting part or all of a fatty acid ester to deoxidization such as deoxidized carnauba wax. Furthermore, the wax includes the following: saturated linear fatty acids such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and melissyl alcohol; polyhydric alcohols such as sorbitol; esters formed of fatty acids such as palmitic acid, stearic acid, behenic acid and montanic acid, and alcohols such as stearyl alcohol, aralkyl alcohol, behenyl alcohol, carnaubyl alcohol, ceryl alcohol and melissyl alcohol; fatty acid amides such as linoleic acid amide, oleic acid amide and lauric acid amide; saturated fatty acid bisamides such as methylenebisstearic acid amide, ethylenebiscapric acid amide, ethylenebislauric acid amide and hexamethylenebisstearic acid amide; unsaturated fatty acid amides such as ethylenebisoleic acid amide, hexamethylenebisoleic acid amide, N,N′-dioleyladipic acid amide and N,N′-dioleylsebacic acid amide; aromatic bisamides such as m-xylenebisstearic acid amide and N,N′-distearylisophthalic acid amide; aliphatic metal salts such as calcium stearate, calcium laurate, zinc stearate and magnesium stearate (generally referred to as metal soap); waxes obtained by grafting an aliphatic hydrocarbon-based wax with a vinyl-based monomer such as styrene and acrylic acid; partially esterified products formed of a fatty acid such as behenic acid monoglyceride and a polyhydric alcohol; and methyl ester compounds having a hydroxyl group obtained by hydrogenation of a vegetable oil and fat.

Among the waxes, hydrocarbon-based waxes such as a paraffin wax and a Fischer-Tropsch wax is preferred from the viewpoint of enhancing the low-temperature fixability and fixation winding resistance.

The content of the wax to be used is preferably 0.5 parts by mass or more and 20 parts by mass or less with respect to 100 parts by mass of the binder resin. In addition, from the viewpoint of simultaneously satisfying the storage stability and the high temperature offset resistance of the toner, the peak temperature at the maximum endothermic peak present in a temperature range of 30° C. or higher and 200° C. or lower in an endothermic curve at the time of temperature increase to be measured with a differential scanning calorimeter (DSC) is preferably 50° C. or higher and 110° C. or lower.

[Coloring Agent]

A coloring agent that can be contained in the toner of the present invention includes the following.

A black coloring agent includes carbon black; and a coloring agent toned to black by using a yellow coloring agent, a magenta coloring agent and a cyan coloring agent. While a pigment may be used alone for the coloring agent, a dye and a pigment are more preferably used in combination to enhance the clarity of the coloring agent in terms of image quality of a full-color image.

A magenta coloring pigment includes the following: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. Pigment Violet 19; and C.I. Vat Red 1, 2, 10, 13, 15, 23, 29 and 35.

A magenta coloring dye includes the following: oil-soluble dyes such as: C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; and C.I. Disperse Violet 1; and basic dyes such as: C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

A cyan coloring pigment includes the following: C.I. Pigment Blue 2, 3, 15:2, 15:3, 15:4, 16 and 17; C.I. Vat Blue 6; C.I. Acid Blue 45, and a copper phthalocyanine pigment in which a phthalocyanine skeleton is substituted with 1 to 5 phthalimidomethyl groups.

A cyan coloring dye includes C.I. Solvent Blue 70.

A yellow coloring pigment includes the following: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. Vat Yellow 1, 3 and 20.

A yellow coloring dye includes C.I. Solvent Yellow 162.

The coloring agent is preferably used in an amount of 0.1 parts by mass or more and 30 parts by mass or less with respect to 100 parts by mass of the binder resin.

[Charge Control Agent]

The toner of the present invention can also contain a charge control agent, if necessary. As the charge control agent contained in the toner, a known one can be utilized. In particular, a metal compound of an aromatic carboxylic acid, which is colorless and is high in charging speed of the toner, and which can stably maintain a constant charge amount, can be particularly utilized.

A charge control agent for negative charging includes a salicylic acid metal compound, a naphthoic acid metal compound, a dicarboxylic acid metal compound, a polymeric compound having a sulfonic acid or a carboxylic acid in a side chain, a polymeric compound having a sulfonic acid salt or a sulfonic acid ester in a side chain, a polymeric compound having a carboxylic acid salt or a carboxylic acid ester in a side chain, a boron compound, a urea compound, a silicon compound and calixarene. A charge control agent for positive charging includes a quaternary ammonium salt compound. The charge control agent may be internally or externally added to the toner particles. The addition amount of the charge control agent is preferably 0.2 parts by mass or more and 10 parts by mass or less with respect to 100 parts by mass of the binder resin.

[Silica Fine Particles]

As the silica fine particles in the present invention, silica fine particles produced by any method such as a wet method, a flame fusion method and a gas phase method are preferably used.

The wet method includes a sol-gel method involving: dropping alkoxysilane in an organic solvent including water present therein; subjecting the mixture to hydrolysis and condensation reaction with a catalyst; removing the solvent from the resulting silica sol suspension; and drying the product to provide a sol-gel silica.

The flame fusion method includes a method involving: gasifying a silicon compound that is gaseous or liquid at normal temperature in advance; and then decomposing and melting the silicon compound in an outer flame, which is formed by supplying an inflammable gas including hydrogen and/or hydrocarbon, and oxygen, to provide the silica fine particles (molten silica). In the flame fusion method, the silica fine particles can be produced from the silicon compound in the outer flame, and at the same time the silica fine particles can be fused and coalesced so that the desired particle diameter and shape are achieved, and then the resultant is cooled and collected by a bag filter or the like. The silicon compound to be used as a raw material is not particularly limited as long as the compound is gaseous or liquid at normal temperature. Examples thereof include: cyclic siloxanes such as hexamethylcyclotrisiloxane, octamethylcyclotetrasiloxane and decamethylcyclopentasiloxane; siloxanes such as hexamethyldisiloxane and octamethyltrisiloxane, alkoxysilanes such as tetramethoxysilane, tetraethoxysilane, methyltrimethoxysilane and dimethyldimethoxysilane, organosilane compounds such as tetramethylsilane, diethylsilane and hexamethyldisilazane, silicon halides such as monochlorosilane, dichlorosilane, trichlorosilane and tetrachlorosilane, and inorganic silicons such as monosilane and disilane.

The gas phase method includes a fumed method involving burning silicon tetrachloride together with a mixed gas of oxygen, hydrogen and a dilution gas (for example, nitrogen, argon and carbon dioxide) at high temperatures to produce the silica fine particles.

The silica fine particles are preferably subjected to a surface treatment for the purpose of subjecting their surfaces to hydrophobizing treatment. As a surface treatment agent in the case, a silane coupling agent or a silicone oil is preferably used.

Examples of the silane coupling agent include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptan, trimethylsilylmercaptan, triorganosilyl acrylate, vinyldimethylacetoxysilane, dimethyldiethoxysilane, dimethyldimethoxysilane, diphenyldiethoxysilane, hexamethyldisiloxane, 1,3-divinyltetramethyldisiloxane, 1,3-diphenyltetramethyldisiloxane, and a dimethylpolysiloxane having 2 to 12 siloxane units per molecule and containing a hydroxyl group bound to one silicon atom in the unit located at the end.

Examples of the silicone oil to be used in the treatment of the silica fine particles to be used in the present invention include a dimethyl silicone oil, an alkyl-modified silicone oil, an α-methylstyrene-modified silicone oil, a chlorophenyl silicone oil and a fluorine-modified silicone oil. The silicone oil is not limited to the above oils. The silicone oil preferably has a viscosity at a temperature of 25° C., of 50 to 1,000 mm²/s. When the viscosity is less than 50 mm²/s, the silicone oil is partially volatilized by the application of heat, thereby easily causing the deterioration in charging property. When the viscosity is more than 1,000 mm²/s, it becomes difficult to handle the silicone oil in terms of treatment operation. A known technique can be used as the method for treating the silicone oil. Examples of the method include: a method involving mixing a silicate fine powder with the silicone oil by using a mixer; a method involving spraying the silicone oil in the silicate fine powder by using a sprayer; or a method involving dissolving the silicone oil in a solvent and then mixing the resultant with a silicate fine powder. The treatment method is not limited thereto.

The silica fine particles of the present invention are particularly preferably treated with hexamethyldisilazane or the silicone oil as a surface treatment agent.

[External Additive]

In the present invention, an external additive may be further added if necessary for the purpose of the enhancement in flowability or the adjustment of the triboelectric charge quantity.

The external additive is preferably inorganic fine particles such as silica, titanium oxide, aluminum oxide and strontium titanate. The inorganic fine particles are preferably subjected to hydrophobizing treatment with a hydrophobizing agent such as a silane compound, a silicone oil or a mixture thereof.

With regard to the specific surface area of the external additive to be used, inorganic fine particles having a specific surface area of 10 m²/g or more and 50 m²/g or less are preferred from the viewpoint of the suppression of the embedding of the external additive.

In addition, the external additive is preferably used in an amount of 0.1 parts by mass or more and 5.0 parts by mass or less with respect to 100 parts by mass of the toner particles.

While the toner particles and the external additive can be mixed using a known mixer such as a Henschel mixer, the apparatus for use in such mixing is not particularly limited as long as the mixing can be performed.

[Production Method]

The method for producing the toner of the present invention is not particularly limited, and a known production method can be used therefor. Herein, a toner production method using a pulverizing technique is described as one example.

In a raw material mixing step, for example, the binder resin and the wax as materials for forming the toner particles, and if necessary other components such as the coloring agent and the charge control agent are weighed in predetermined amounts, and blended and mixed. One example of a mixing apparatus includes a double cone mixer, a V-type mixer, a drum-type mixer, a super mixer, a Henschel mixer, a Nauta mixer, and Mechano Hybrid (manufactured by Nippon Coke & Engineering Co., Ltd.).

Then, the mixed materials are melted and kneaded, and the wax and the like are dispersed in the binder resin. In a melting and kneading step, a batch-type kneader such as a pressure kneader and a Banbury mixer, or a continuous kneader can be used, and a single-screw or twin-screw extruder is mainly used because of advantages of continuous production. Examples thereof include: a KTK-type twin-screw extruder (manufactured by Kobe Steel, Ltd.); a TEM-type twin-screw extruder (manufactured by Toshiba Machine Co., Ltd.); a PCM kneader (manufactured by Ikegai Corporation); a twin-screw extruder (manufactured by K.C.K. Corporation); a co-kneader (manufactured by Buss AG); and KNEADEX (manufactured by Nippon Coke & Engineering Co., Ltd.). Furthermore, a resin composition obtained by the melting and kneading may be rolled by a twin roll or the like, and cooled by water or the like in a cooling step.

Then, the cooled product of the resin composition is pulverized so as to have the desired particle diameter in a pulverizing step. In the pulverizing step, the cooled product is coarsely pulverized by a pulverizer such as a crusher, a hammer mill or a feather mill, and is then finely pulverized by, for example, Kryptron System (manufactured by Kawasaki Heavy Industries, Ltd.), Super Rotor (manufactured by Nisshin Engineering Inc.), Turbo Mill (manufactured by Turbo Kogyo Co., Ltd.), or a fine pulverizer of an air jet system.

Thereafter, classification is if necessary performed using a classifier or a sieving machine such as Elbow-Jet (manufactured by Nittetsu Mining Co., Ltd.) of an inertial classification system, Turboplex (manufactured by Hosokawa Micron Corporation) of a centrifugal classification system, TSP separator (manufactured by Hosokawa Micron Corporation), or Faculty (manufactured by Hosokawa Micron Corporation) to provide the toner particles.

In addition, after the pulverizing, the surface treatment of the toner particles, such as a spheronization treatment, can be if necessary performed using Hybridization System (manufactured by Nara Machinery Co., Ltd.), Mechanofusion System (manufactured by Hosokawa Micron Corporation), Faculty (manufactured by Hosokawa Micron Corporation), or Meteorainbow MR Type (manufactured by Nippon Pneumatic Mfg. Co., Ltd.).

In the present invention, the following is particularly preferably performed: the silica fine particles are dispersed on the surfaces of the toner particles obtained by the above production method, and the silica fine particles are stuck to the surfaces of the toner particles by a surface treatment with hot air while being dispersed.

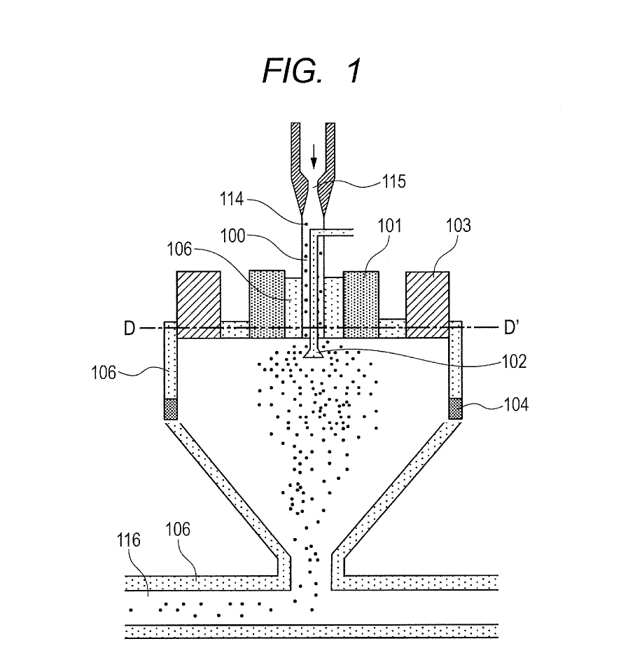

In the present invention, for example, the toner can be obtained by performing the surface treatment with hot air using a surface treatment apparatus illustrated in FIG. 1, and if necessary performing classification.

The surface treatment with hot air is particularly preferable as follows: the toner is ejected by spraying from a high-pressure air supply nozzle, the surface of the ejected toner is treated by exposing the toner to hot air, and the temperature of the hot air falls within the range of from 100° C. or more to 450° C. or less.

Herein, the surface treatment method using hot air is schematically described with respect to FIG. 1, but is not limited thereto. FIG. 1 is a cross-sectional view illustrating one example of the surface treatment apparatus used in the present invention. Specifically, the inorganic fine particles are dispersed on the surface of the toner particles, and thereafter supplied to the surface treatment apparatus. Then, toner particles 114 supplied from a toner supply port 100 are accelerated by injection air sprayed from a high pressure air supply nozzle 115, and travel to an air flow spraying member 102 located below the high pressure air supply nozzle 115. The air flow spraying member 102 sprays diffusion air, and this diffusion air allows the toner particles to be diffused outward. At this time, the flow rate of the injection air and the flow rate of the diffusion air can be regulated to thereby control the diffusion state of the toner.

In addition, for the purpose of preventing the toner particles from being fused, a cooling jacket 106 is provided on each of the outer periphery of the toner supply port 100, the outer periphery of the surface treatment apparatus, and the outer periphery of a transport pipe 116. It should be noted that cooling water (preferably, an antifreeze liquid such as ethylene glycol) is preferably passed through the cooling jacket. On the other hand, the surfaces of the toner particles diffused by the diffusion air are treated with hot air supplied from a hot air supply port 101. At this time, the hot air temperature C (° C.) is preferably 100° C. or higher and 450° C. or lower, more preferably 100° C. or higher and 400° C. or lower, and particularly preferably 150° C. or higher and 300° C. or lower.

When the hot air temperature is lower than 100° C., the variation in surface roughness may occur in the surfaces of the toner particles. In addition, when the temperature exceeds 450° C., the molten state progresses to so large an extent that the coalescence of the toners may progress to cause the coarsening and fusion of the toner.

The toner particles whose surfaces have been treated with the hot air are cooled by cool air supplied from a cool air supply port 103 provided on the outer periphery of the upper portion of the apparatus. In the case, for the purposes of controlling the temperature distribution in the apparatus and controlling the surface state of the toner, cool air may be introduced from a second cool air supply port 104 provided on the side surface of the main body of the apparatus. A slit shape, a louver shape, a porous plate shape, a mesh shape, or the like can be used in the outlet of the second cool air supply port 104, and a direction horizontal to a central direction or a direction along the wall surface of the apparatus can be selected as the direction in which the cool air is introduced depending on purposes. In the case, the cool air temperature E (° C.) is preferably −50° C. or higher and 10° C. or lower, and more preferably −40° C. or higher and 8° C. or lower. In addition, the cool air is preferably dehumidified cool air. Specifically, the absolute moisture content of the cool air is preferably 5 g/m³ or less, and more preferably 3 g/m³ or less.

When the cool air temperature is in the above range, spheronization can be favorably performed while generation of coalescence between the particles is suppressed. In addition, when the absolute moisture content of the cool air is 5 g/m³ or less, the elution rate of the wax is appropriate to easily control the sticking ratio of the silica fine particles within the range of the present application.

Thereafter, the cooled toner particles are sucked by a blower, and recovered with a cyclone or the like through the transport pipe 116.

In addition, the toner particles may also be if necessary subjected to a further surface modification and spheronization treatment by using Hybridization System manufactured by Nara Machinery Co., Ltd. or Mechanofusion System manufactured by Hosokawa Micron Corporation. In such a case, a sieving machine such as High Bolter (manufactured by Shin Tokyo Kikai Co., Ltd.) that is a wind system sieve may also be if necessary used.

Thereafter, if necessary, other inorganic fine particles may be externally added to impart flowability and to enhance charge stability. One example of a mixing apparatus includes a double cone mixer, a V-type mixer, a drum-type mixer, a super mixer, a Henschel mixer, a Nauta mixer, and MECHANO HYBRID (manufactured by Nippon Coke & Engineering Co., Ltd.).

Next, measurement methods of respective physical properties with respect to the present invention will be described.

[Measurement Method of Maximum Consolidation Stress (a) and Uniaxial Collapse Stress (b)]

The maximum consolidation stress (a) and the uniaxial collapse stress (b) can be measured by Shear Scan TS-12 (manufactured by Sci-Tec Inc.). In Shear Scan, measurement is performed with respect to the principle according to Mohr-Coulomb model described in CHARACTERIZING POWDER FLOWABILITY (published on Jan. 24, 2002) written by Prof. Virendra M. Puri.

Specifically, the measurement was performed in a room temperature environment (23° C., 60% RH) by using a linear shearing cell (cylindrical shape, diameter: 80 mm, volume: 140 cm³) to which a shear force can be linearly applied in the sectional direction. The toner is charged into the cell, a vertical load is applied so as to be 1.0 kPa, and a consolidated powder layer is produced so as to be in the closest packing state at the vertical load (measurement by Shear Scan is preferred in the present invention because the pressure in the consolidation state can be automatically detected and the layer can be produced with no individual difference). Similarly, consolidated powder layers are formed by setting the vertical load to 3.0 kPa, 5.0 kPa and 7.0 kPa. Then, a shear force is gradually applied to a sample formed at each of the vertical load while the vertical load applied for forming the consolidated powder layer is continuously applied, and a test for measuring the fluctuation of a shear stress at the time is performed to determine a stationary point. It is determined as follows when the consolidated powder layer reaches the stationary point: when the displacement of the shear stress and the displacement in the vertical direction of a load applying unit for applying the vertical load are reduced and both of them have a stable value in the above test, the consolidated powder layer is considered to reach the stationary point. Then, the vertical load is gradually removed from the consolidated powder layer that has reached the stationary point, a failure envelope at each load (plot of vertical load stress vs shear stress) is created, and a Y-intercept and a slope are determined. In the analysis by the Mohr-Coulomb model, the uniaxial collapse stress and the maximum consolidation stress are represented by the following expressions, and the Y-intercept represents a “cohesion force” and the slope represents an “internal frictional angle.”

Uniaxial collapse stress (b)=2c(1+sin φ)/cos φ

Maximum consolidation stress (a)=((A−(A² sin² φ−τₛₛₚ² cos² φ)^{0.5})/cos² φ)×(1+sin φ)−(c/tan φ)

(A=σₛₛₚ+(c/tan φ), c=cohesion force, φ=internal frictional angle, τₛₛₚ=c+σₛₛₚ×tan φ, σₛₛₚ=vertical load at the stationary point)

The uniaxial collapse stress and the maximum consolidation stress calculated at each of the loads are plotted (Flow Function Plot), and a straight line is drawn based on the plot. The straight line is used to determine the uniaxial collapse stress at the time of a maximum consolidation stress of 10.0 kPa.

In the present invention, it is important to control the uniaxial collapse stress of the toner at the time of a maximum consolidation stress of 10.0 kPa to 2.5 kPa or more and 3.5 kPa or less.

[Calculation of Coverage Rate X]

The coverage rate X in the present invention is calculated by analyzing a toner surface image captured by Hitachi ultra-high resolution field emission scanning electron microscope S-4800 (Hitachi High-Technologies Corporation) by using image analysis software Image-Pro Plus ver. 5.0 (Nippon Roper K.K.). The image-capturing conditions of S-4800 are as follows.

(1) Specimen Preparation

A conductive paste is thinly applied to a specimen stage (aluminum specimen stage: 15 mm×6 mm), and the toner is blown thereon. Further, air-blowing is applied to remove an excessive toner from the specimen stage and to dry the remaining toner sufficiently. The specimen stage is set on a specimen holder, and the height thereof is regulated to 36 mm by a specimen height gauge.

(2) Setting of Conditions of Observation with 5-4800

The calculation of the coverage rate X is performed using an image obtained by observing a reflection electron image with S-4800. The reflection electron image can be used to measure the coverage rate X with excellent accuracy because the inorganic fine particles are less charged-up than the case of a secondary electron image. It should be noted that when particles other than the silica fine particles are present on the surfaces of the toner particles, elemental analysis is performed by an energy dispersive X-ray analyzer (EDAX) to identify the silica fine particles, and then the coverage rate X is calculated.

Liquid nitrogen is injected to an anti-contamination trap mounted to a mirror body of S-4800 until the liquid nitrogen overflows, and the trap is left to stand for 30 minutes. The “PC-SEM” of S-4800 is started to perform flushing (an FE chip, which is an electron source, is cleaned). An acceleration voltage display portion in the control panel on the screen is clicked and the [flushing] button is pressed to open a flushing execution dialog. The flushing intensity is confirmed to be 2, and the flushing is executed. The emission current due to flushing is confirmed to be 20 to 40 HA. The specimen holder is inserted to a specimen chamber of the mirror body of S-4800. [Origin] on the control panel is pressed to transfer the specimen holder to the observation position.

The acceleration voltage display portion is clicked to open an HV setting dialog, and the acceleration voltage is set to [0.8 kV] and the emission current is set to [20 μA]. In the [Basics] tab of the operation panel, signal selection is set to [SE], [upper (U)] and [+BSE] are selected for an SE detector, and [L.A.100] is selected in a selection box on the right of [+BSE] to lead to the observation mode with the reflection electron image. Similarly, in the [Basics] tab of the operation panel, the probe current, the focus mode, and WD of an electron optical system condition block are set to [Normal], [UHR], and [3.0 mm], respectively. The [ON] button in the acceleration voltage display portion of the control panel is pressed to apply the acceleration voltage.

(3) Focus Adjustment

The focus knob [COARSE] on the operation panel is rotated, and the aperture alignment, where some degree of focus is obtained, is adjusted. The [Align] in the control panel is clicked to display an alignment dialog, and [beam] is selected. The STIGMA/ALIGNMENT knob (X, Y) on the operation panel is rotated to allow the beam to be displayed to move to the center of the concentric circles. Then, [Aperture] is selected, and the STIGMA/ALIGNMENT knob (X, Y) is rotated one at a time to perform focusing so that the movement of an image may be stopped or minimized. The aperture dialog is closed, and focus is achieved using autofocus. Thereafter, the magnification is set to 50,000 (50 k), focus adjustment is performed, as described above, using the focus knob and the STIGMA/ALIGNMENT knob, and focus is again achieved using autofocus. The operation is repeated to achieve focus. Herein, since the accuracy of the coverage rate measurement easily becomes low when the observation surface has a large tilt angle, a toner particle whose surface has as small a tilt as possible is selected and analyzed by selecting such a toner particle that the entire surface to be observed is simultaneously in focus during focus adjustment.

(4) Image Storage

Brightness adjustment is performed using an ABC mode, and a photograph is taken with a size of 640×480 pixels, and stored. The image file is used to perform the following analysis. One photograph for each toner particle is taken, and images are obtained for at least 30 toner particles.

(5) Image Analysis

In the present invention, the coverage rate X is calculated by using the following analysis software to subject the image obtained by the above procedure to binarization processing. Herein, the above single image is divided into 12 squares and each square is analyzed. The analysis conditions of the image analysis software, Image-Pro Plus ver. 5.0, are as follows.

### Software: Image-ProPlus 5.1J

“Count/size” and then “Option” are sequentially selected from “Measurement” in the toolbar, and binarization conditions are set. “8-Connect” is selected in an object extraction option, and “Smoothing” is set to 0. In addition, “Pre-Filter”, “Fill Holes”, and “Convex Hull” are not selected, and “Clean Borders” is set to “None”. “Measurement item” is selected from “Measurement” in the toolbar, and “2 to 107” is input to the area screening range.

The coverage rate is calculated by surrounding a square region. Herein, the surrounding is performed so that an area (C) of the region may be 24,000 to 26,000 pixels. Automatic binarization is performed by “Processing”-binarization, and the total area (D) of the silica-free regions is calculated.

The coverage rate X is calculated using the following expression from the area C of the square region and the total area D of the silica-free regions.

Coverage X (%)=100−(D/C×100)

The average value of all the obtained data is defined as the coverage rate X in the present invention.

[Calculation of Sticking Ratio (A) of Silica Fine Particles]

The sticking ratio of the silica fine particles is calculated from the amount of the silica fine particles in the toner in the normal state, and the amount of the silica fine particles remaining after the removal of the silica fine particles not stuck to the surface of the toner.

(1) Removal of Inorganic Fine Particles that are not Stuck

The inorganic fine particles that are not stuck are removed as described below.

160 Grams of sucrose are added to 100 ml of ion-exchanged water and are dissolved therein while being warmed with hot water to prepare a sucrose solution. A solution prepared by adding 23 ml of the sucrose solution and 6.0 ml of a nonionic surfactant, preferably Contaminon N (produced by Wako Pure Chemical Industries, Ltd.: trade name) is charged to a 50 ml sealable sample bottle made of polyethylene, 1.0 g of a measurement specimen is added thereto, and the mixture is stirred by lightly shaking the sealed bottle. After that, the bottle is left to stand for 1 hour. The sample that left to stand for 1 hour is shaken by a KM shaker (Iwaki Sangyo: trade name) at 350 spm for 20 minutes. Herein, the angle of shaking is set so that a strut of shaking moves forward by 15 degrees and backward by 20 degrees regarding the just above position (vertical) of the shaker as 0 degrees. The sample bottle is fixed to a fixing holder mounted to the tip of the strut (the lid of the sample bottle is fixed onto the extension of the center of the strut). The shaken sample is rapidly transferred to a vessel for centrifugation. The sample that has been transferred to the vessel for centrifugation is subjected to centrifugation by a high-speed cooling centrifuge H-9R (manufactured by Kokusan Co., Ltd.: trade name) under conditions of a preset temperature of 20° C., the shortest acceleration-deceleration time, a rotation number of 3,500 rpm and a rotation time of 30 minutes. The toner separated at the uppermost portion is recovered and filtered with a vacuum filter, followed by drying with a dryer for 1 hour or more.

The sticking ratio is calculated by the following expression.

Sticking ratio (A)={1−(P1−P2)/P1}×100

(In the equation, P1 represents the SiO₂ amount “% by mass” of the initial toner, and P2 represents the SiO₂ amount “% by mass” of the toner after the removal of the silica fine particles not stuck to the surface of the toner by the above-mentioned approach. The SiO₂ amount of the toner is calculated by drawing a calibration curve from the SiO₂intensity of the toner determined by XRF measurement.)

[Calculation of Particle Diameter of Silica Fine Particles]

The number-average particle diameter of the primary particles of the silica fine particles is calculated from an image of the surface of the toner captured by Hitachi ultra-high resolution field emission scanning electron microscope S-4800 (Hitachi High-Technologies Corporation). The image-capturing conditions of S-4800 are as follows.

The operations (1) and (2) are performed in the same manner as in “Calculation of coverage rate X” described above, and the magnification is set to 50,000 to perform focus adjustment on the surface of the toner in the same manner as in the operation (3). After that, brightness adjustment is performed using the ABC mode. Thereafter, the magnification is set to 100,000, and then the focus knob and the STIGMA/ALIGNMENT knob are used to perform focus adjustment in the same manner as in the operation (3), and focus is further achieved using autofocus. The focus adjustment operation is repeated and focusing is performed at a magnification of 100,000.

Thereafter, the particle diameters of at least 300 inorganic fine particles on the surface of the toner are measured to determine the number-average particle diameter of primary particles. Herein, since the silica fine particles are also present as an aggregate, the maximum diameter of the silica fine particle that can be identified as a primary particle is determined, and the obtained maximum diameter is subjected to arithmetic average to provide the number-average particle diameter of primary particles.

<Measurement Method for Weight Average Particle Diameter (D4)>

The weight average particle diameter (D4) of toner particles is calculated through analysis of measurement data obtained by measurement with 25000 effective measurement channels by using a precision particle diameter distribution measuring apparatus equipped with a 100 μm aperture tube and employing an aperture electric resistance method, “Coulter Counter Multisizer 3” (registered trademark, manufactured by Beckman Coulter, Inc.) and accompanying dedicated software for setting measurement conditions and analyzing measurement data, “Beckman Coulter Multisizer 3 Version 3.51” (manufactured by Beckman Coulter, Inc.).

As an aqueous electrolyte solution for used in the measurement, one obtained by dissolving special grade sodium chloride in ion-exchanged water into a concentration of approximately 1% by mass, such as “ISOTON II” (manufactured by Beckman Coulter, Inc.), can be used.

Incidentally, before the measurement and analysis, the dedicated software is set as follows.

In a “screen for changing standard operation method (SOM)” of the dedicated software, the total count number in the control mode is set to 50000 particles, the number of measurements is set to one, and a Kd value is set to a value obtained by using “standard particles of 10.0 μm” (Beckman Coulter, Inc.). A threshold value and noise level are automatically set by pressing a threshold value/noise level measurement button. In addition, the current is set to 1600 μA, the gain is set to 2, the aqueous electrolyte solution is set to ISOTON II, and a check is put in an item of aperture tube flush to be performed after the measurement.

In a “screen for setting conversion from pulses to particle size” of the dedicated software, a bin interval is set to logarithmic particle size, the number of particle size bins is set to 256, and a particle size range is set to 2 μm to 60 μm.

The measurement method is specifically performed as follows.

1. Approximately 200 ml of the above-described aqueous electrolyte solution is put in a 250 ml round bottom glass beaker intended for use with Multisizer 3 and the beaker is placed in a sample stand and counterclockwise stirring with a stirrer rod is carried out at 24 rotations per second. Contamination and air bubbles within the aperture tube have precedently been removed by an “aperture flush” function of the analysis software.

2. Approximately 30 ml of the above-described aqueous electrolyte solution is put in a 100 ml flat bottom glass beaker, and to this beaker, approximately 0.3 ml of a dilution prepared by three-fold by mass dilution with ion-exchanged water of “Contaminon N” (a 10 mass % aqueous solution of a neutral pH 7 detergent for cleaning precision measurement instruments, containing a nonionic surfactant, an anionic surfactant and an organic builder, manufactured by Wako Pure Chemical Industries, Ltd.) is added as dispersant.

3. In an “Ultrasonic Dispersion System Tetora 150” (Nikkaki Bios Co., Ltd.), that is, an ultrasonic disperser with an electrical output of 120 W equipped with two oscillators of oscillation frequency of 50 kHz disposed with their phases displaced by 180°, a prescribed amount of ion-exchanged water is introduced into a water tank of the ultrasonic disperser and approximately 2 ml of the Contaminon N is added to the water tank.

4. The beaker described in the item 2. is set into a beaker holder hole of the ultrasonic disperser and the ultrasonic disperser is started. The height of the beaker is adjusted in such a manner that the resonant state of the surface of the aqueous electrolyte solution within the beaker is at the maximum level.

5. With the aqueous electrolyte solution within the beaker set as described in the item 4. irradiated with ultrasonic waves, approximately 10 mg of toner particles is added to the aqueous electrolyte solution in small aliquots to be dispersed therein. The ultrasonic dispersion treatment is continued for another 60 seconds. Incidentally, the water temperature in the water tank is appropriately controlled during the ultrasonic dispersion to be 10° C. or more and 40° C. or less.

6. The aqueous electrolyte solution containing the dispersed toner particles as described in the item 5. is added, by using a pipette, dropwise into the round bottom beaker set in the sample stand as described in the item 1. so as to make adjustment for attaining a measurement concentration of approximately 5%. The measurement is then performed until the number of measured particles reaches 50000.

7. The measurement data is analyzed by the above-described dedicated software accompanying the apparatus, and the weight average particle diameter (D4) is calculated. Incidentally, an “average size” shown in an analysis/volume statistical value (arithmetic mean) screen with graph/volume % set in the dedicated software corresponds to the weight average particle diameter (D4).

<Method of Measuring Average Circularity of Toner Particles>

The average circularity of the toner particles is measured with the “FPIA-3000” (Sysmex Corporation), a flow-type particle image analyzer, using the measurement and analysis conditions from the calibration process.

The method of measurement is as follows. First, about 20 mL of ion-exchanged water from which solid impurities have been removed is placed in a glass vessel. Next, about 0.2 mL of a dilution prepared by diluting Contaminon N (a 10 wt % aqueous solution of a neutral (pH 7) cleanser for cleaning precision analyzers which is composed of a nonionic surfactant, an anionic surfactant and an organic builder; available from Wako Pure Chemical Industries, Ltd.) with an approximately 3-fold weight of ion-exchanged water is added to this as the dispersant. About 0.02 g of the measurement sample is then added and dispersion treatment is carried out for 2 minutes using an ultrasonic disperser, thereby forming a dispersion for measurement. The dispersion is suitably cooled at this time to a temperature of at least 10° C. and not more than 40° C. Using a desktop ultrasonic cleaner/disperser (e.g., VS-150 from Velvo-Clear) having a oscillation frequency of 50 kHz and an electrical output of 150 W as the ultrasonic disperser, a given amount of ion-exchanged water was placed in the water tank and about 2 mL of Contaminon N was added to this tank.

Measurement was carried out using a flow-type particle image analyzer equipped with, as the object lens, a “UPlanApro” (enlargement, 10×; numerical aperture, 0.40), and using the particle sheath “PSE-900A” (from Sysmex Corporation) as a sheath reagent.

The dispersion prepared according to the procedure described above was introduced to the flow-type particle image analyzer and, in the HPF measurement mode, 3,000 toner particles were measured in the total count mode. Next, setting the binarization threshold during particle analysis to 85%, and restricting the analyzed particle diameter to a circle-equivalent diameter of at least 1.985 μm and less than 39.69 μm, the average circularity of the toner particles was determined.

For this measurement, automatic focal point adjustment is performed prior to the start of the measurement using reference latex particles (for example, a dilution with ion-exchanged water of “RESEARCH AND TEST PARTICLES Latex Microsphere Suspensions 5200A” from Duke Scientific). It is preferable to subsequently carry out focal point adjustment every 2 hours following the start of measurement.

In this invention, use is made of a flow-type particle image analyzer for which the calibration work by Sysmex Corporation was carried out and for which a calibration certification issued by Sysmex Corporation was received. Aside from limiting the diameters of the analyzed particle to a circle-equivalent diameter of at least 1.985 μm and less than 39.69 μm, measurement is carried out under the measurement and analysis conditions at the time that the calibration certificate was received.

The measurement principle employed in the FPIA-3000 (from Sysmex Corporation) flow-type particle image analyzer is to capture the flowing particles as still images and carry out image analysis. The sample that has been added to the sample chamber is fed to a flat sheath flow cell with a sample suctioning syringe. The sample fed into the flat sheath flow cell is sandwiched between the sheath reagent, forming a flattened flow.

The sample passing through the flat sheath flow cell is irradiated at 1/60-second intervals with a strobe light, enabling the flowing particles to be captured as still images. Because the flow is flattened, the images are captured in a focused state. The particle images are captured with a CCD camera, and the captured images are image processed with a 512×512 pixel image processing resolution (0.37 μm×0.37 μm per pixel), following which contour extraction is carried out on each particle image, and the projected area S, periphery length L and the like for the particle image are calculated.

Next, the circle-equivalent diameter and circularity are determined using the above surface area S and periphery length L. The circle-equivalent diameter is the diameter of the circle that has the same area as the projected area of the particle image.

The circularity is defined as the value provided by dividing the circumference of the circle determined from the circle-equivalent diameter by the periphery length of the particle's projected image and is calculated using the following formula.

Circularity=2×(π×S)^{1/2}/L

When the particle image is circular, the circularity is 1.000. As the degree of unevenness in the circumference of the particle image becomes larger, the circularity value becomes smaller. After calculating the circularity of each particle, the range in circularity from 0.200 to 1.000 is divided by 800, the arithmetic mean of the resulting circularities is calculated, and the resulting value is treated as the average circularity.

[Description of Image Forming Method]

The image forming method of the present invention includes a charging step of charging a surface of a photosensitive member, a latent image-forming step of forming an electrostatic latent image on the photosensitive member by light exposure, a developing step of developing the electrostatic latent image by the toner having the above configuration of the present invention to form a toner image, a transfer step of primarily transferring the toner image to an intermediate transfer member and then secondarily transferring the toner image on the intermediate transfer member to a transfer material, and a cleaning step of removing a transfer residue toner remaining on the intermediate transfer member after the primary transfer step from the intermediate transfer member by a cleaning member.

Then, one example is shown with respect to an image forming apparatus in the present invention.

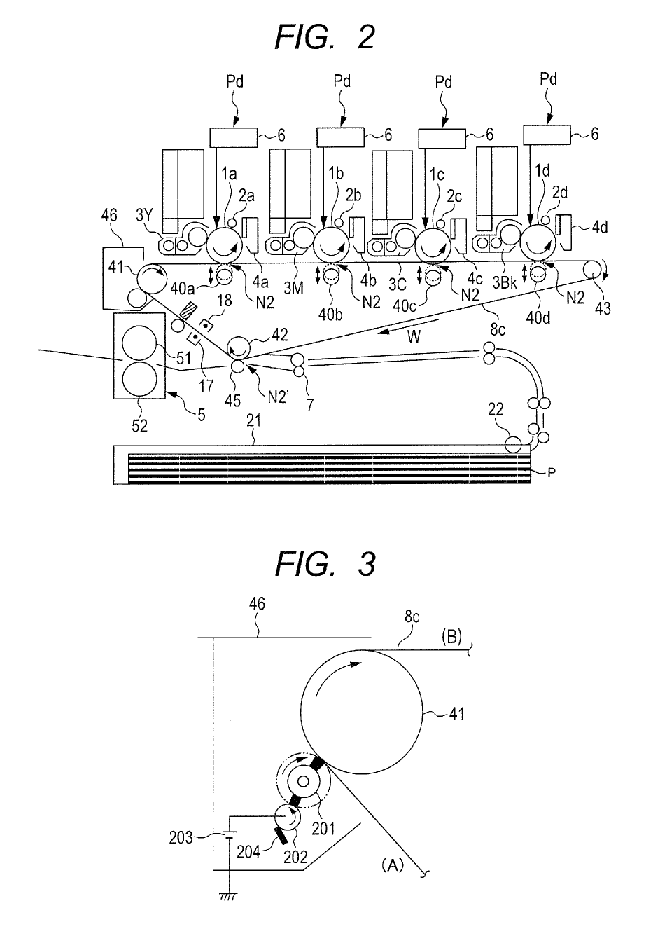

FIG. 2 illustrates a schematic configuration of an embodiment of an image forming apparatus according to the present invention. The image forming apparatus of the present embodiment is a tandem-type electrophotographic image forming apparatus using a multi transfer system on an intermediate transfer member, including a plurality of image forming portions arranged in parallel, each image forming portion including an image bearing member and respective devices that perform charging, light exposure and developing for forming a toner image on the image bearing member, wherein toner images of respective colors formed on a plurality of image bearing members are multi-transferred on an intermediate transfer member as a second image bearing member, and thereafter the multi-transferred toner images on the intermediate transfer member as the second image bearing member are collectively transferred on a recording material.

As illustrated in FIG. 2, the image forming apparatus of the present embodiment includes respective image forming portions Pa, Pb, Pc and Pd that form images of respective colors of yellow, magenta, cyan and black. In the respective image forming portions, primary charging devices 2a, 2b, 2c and 2d, a light exposure system 6, and developing apparatuses 3Y, 3M, 3C and 3Bk of respective colors of yellow, magenta, cyan and black are used to perform charging, light exposure and developing for respective photosensitive drums 1a, 1b, 1c and 1d, forming the toner images of the respective colors on the respective photosensitive drums 1a to 1d.

The image forming apparatus also includes, as a conveyance device, a belt-shaped intermediate transfer member serving as a second image bearing member, namely, an intermediate transfer belt 8c that bears the multi-transferred toner images from the respective photosensitive drums 1a to 1d, and conveys the toner images to a secondary transfer site N2′ where the toner images are collectively transferred on a recording material P. The intermediate transfer belt 8c is wound over an intermediate transfer belt driving roller 43, a tension roller 41, and a secondary transfer opposite roller 42 as a secondary transfer opposite member, and rotated in the direction of arrow W in FIG. 2.

The respective photosensitive drums 1a to 1d are opposite to primary transfer charging rollers 40a, 40b, 40c and 40d as transfer charging devices, respectively, with the intermediate transfer belt 8c interposed therebetween.

When an image forming operation is initiated, the intermediate transfer belt 8c is rotated in the direction of arrow W, the toner images of the respective colors formed on the respective photosensitive drums 1a to 1d are sequentially stacked and electrostatically transferred on the intermediate transfer belt 8c at a primary transfer site N2 by actions of respective primary transfer charging rollers 40a to 40d.

According to the present embodiment, the respective transfer charging rollers 40a to 40d supply charge over a region wider than the image forming region on the intermediate transfer belt 8c, to transfer the toner images from the respective photosensitive drums 1a to 1d to the intermediate transfer belt 8c.

On the other hand, the recording material P accommodated in a recording material accommodating cassette 21 is fed into the image forming apparatus by a recording material supply roller 22, and sandwiched between resist rollers 7. Thereafter, the tip of the toner images multi-transferred on the intermediate transfer belt 8c is fed to a secondary transfer portion N2′ so as to be synchronized with a secondary transfer charging roller 45 as a secondary transfer charging device and the secondary transfer opposite roller 42 as the secondary transfer opposite member that make the secondary transfer portion N2′, the roller 42 and the roller 45 being opposite to each other and abutting with the rear surface (inner side) and the front surface (external side) of the intermediate transfer belt 8c, respectively, and the toner images on the intermediate transfer belt 8c are collectively transferred to the recording material P by the action of the secondary transfer charging roller 45.

Thereafter, the recording material P that bears the unfixed toner images is conveyed to a fixing apparatus 5, and heated and pressurized, and thus the unfixed toner images are fixed on the recording material P to form a permanent image. In addition, the toner and the like remaining on the intermediate transfer belt 8c after the toner images are secondarily transferred to the recording material P are removed by an intermediate transfer belt cleaner 46 having a cleaning device after discharged by discharging devices 17 and 18 for the removal of electrostatic adsorption force.

Then, a cleaning method of the intermediate transfer belt for use in the present invention is described.

The cleaning method is described, as one example, with respect to a fur brush cleaning method that can be used in a tandem-type image forming apparatus in which multi toner images are formed on an intermediate transfer member, but is not limited to the fur brush cleaning method.

FIG. 3 is an enlarged view of the intermediate transfer belt cleaning apparatus 46. In FIG. 3, the intermediate transfer belt cleaning apparatus 46 is provided with a conductive fur brush 201 that is opposite to the tension roller 41 and is in contact with the intermediate transfer belt 8c with rotating. The rotation direction of the conductive fur brush 201 is the same as the direction of the intermediate transfer belt 8c. That is, the brush and the belt are mutually reversely surface moved at a nip position. The conductive fur brush 201 is in contact with a metal roller 202, and a voltage is applied thereto from a power supply 203. A voltage having an opposite charge to the charge of the toner is applied to the metal roller 202 that is in contact with the conductive fur brush 201.

The difference in potential is generated between the metal roller 202 and the conductive fur brush 201 by the resistance of the conductive fur brush 201, allowing the toner removed from the intermediate transfer belt 8c to be transferred from the conductive fur brush 201 to metal roller 202. The toner transferred to the metal roller 202 is scraped off by a blade 204 and recovered. The difference in potential is similarly generated also between the intermediate transfer belt 8c and the conductive fur brush 201, and the electrostatic force by the electric field and the scraping force by contacting allow the toner to be recovered by the conductive fur brush 201. For example, when a voltage of +700 V is applied to the metal roller 202, the conductive fur brush 201 has a voltage of +400 V to clean the negative toner on the intermediate transfer belt 8c.

[Physical Properties of Transfer Material]

Physical property values of the transfer material in the present invention are measured by the following measurement methods. The basis weight of the transfer material was measured according to JIS-P-8124. The Bekk smoothness of the surface of the transfer material was measured according to JIS-P-8119.

### EXAMPLES

While the basic configurations and features of the present invention are described above, the present invention is specifically described below with respect to Examples. However, the present invention is not limited to the Examples at all.

### Production Example of Binder Resin 1

A 4-liter four-necked glass flask was loaded with 76.9 parts by mass (0.167 mol) of polyoxypropylene(2.2)-2,2-bis(4-hydroxyphenyl)propane, 24.1 parts by mass (0.145 mol) of terephthalic acid and 0.5 parts by mass of titanium tetrabutoxide, was equipped with a thermometer, a stirrer rod, a condenser and a nitrogen introduction tube, and was set in a mantle heater. Then, the content of the flask was replaced with nitrogen gas. After that a temperature in the flask was gradually increased while the mixture was stirred. The mixture was subjected to a reaction for 4 hours while being stirred at a temperature of 200° C. (First reaction step). Thereafter, 2.0 parts by mass (0.010 mol) of trimellitic anhydride were added to the resultant, and the mixture was subjected to a reaction at 180° C. for 1 hour (second reaction step) to provide binder resin 1 as a polyester resin.

The acid value and the hydroxyl value of binder resin 1 were 10 mg KOH/g and 65 mg KOH/g, respectively. In addition, the weight average molecular weight (Mw) was 8,000, the number average molecular weight (Mn) was 3,500 and the peak molecular weight (Mp) was 5,700 with respect to molecular weights measured by GPC, and the softening point was 90° C.

### Production Example of Binder Resin 2

A 4-liter four-necked glass flask was loaded with 71.3 parts by mass (0.155 mol) of polyoxypropylene(2.2)-2,2-bis(4-hydroxyphenyl)propane, 24.1 parts by mass (0.145 mol) of terephthalic acid and 0.6 parts by mass of titanium tetrabutoxide, was equipped with a thermometer, a stirrer rod, a condenser and a nitrogen introduction tube, and was set in a mantle heater. Then, the content of the flask was replaced with nitrogen gas. After that a temperature in the flask was gradually increased while the mixture was stirred. The mixture was subjected to a reaction for 2 hours while being stirred at a temperature of 200° C. (First reaction step). Thereafter, 5.8 parts by mass (0.030% by mol) of trimellitic anhydride were added to the resultant, and the mixture was subjected to a reaction at 180° C. for 10 hours (second reaction step) to provide binder resin 2 as a polyester resin.

The acid value and the hydroxyl value of binder resin 2 were 15 mg KOH/g and 7 mg KOH/g, respectively. In addition, the weight average molecular weight (Mw) was 200,000, the number average molecular weight (Mn) was 5,000 and the peak molecular weight (Mp) was 10,000 with respect to molecular weights measured by GPC, and the softening point was 130° C.

### Polymer Production Example 1

Low density polyethylene (Mw: 1,400, Mn: 850, peak temperature of the maximum endothermic peak measured by

| | |
|---|---|
| DSC: 100° C.) | 18.0 parts by mass |
| Styrene | 66.0 parts by mass |
| n-Butyl acrylate | 13.5 parts by mass |
| Acrylonitrile | 2.5 parts by mass |

The materials were charged to an autoclave, and the system was replaced with N₂. After that, a temperature in the system was increased and kept at 180° C. while the mixture was stirred. 50 Parts by mass of a 2-mass % xylene solution of t-butyl hydroperoxide were continuously dropped into the system for 5 hours, and the mixture was cooled, followed by the separation and removal of the solvent. Thus, a polymer A in which the low density polyethylene reacted with a vinyl resin component was obtained. The molecular weight of polymer A was measured, and the weight average molecular weight (Mw) was 7,100 and the number average molecular weight (Mn) was 3,000. Furthermore, a dispersion obtained by dispersing the polymer in a 45-vol % aqueous solution of methanol had a transmission at a wavelength of 600 nm measured at a temperature of 25° C. of 69%.

### Polymer Production Example 2

Low density polyethylene (Mw: 1,300, Mn: 800, peak temperature of the maximum endothermic peak measured by

| | |
|---|---|
| DSC: 95° C.) | 20.0 parts by mass |
| o-Methyl styrene | 65.0 parts by mass |
| n-Butyl acrylate | 11.0 parts by mass |
| Methacrylonitrile | 4.0 parts by mass |

The materials were charged to an autoclave, and the system was replaced with N₂. After that, a temperature in the system was increased and kept at 170° C. while the mixture was stirred. 50 Parts by mass of a 2-mass % xylene solution of t-butyl hydroperoxide were continuously dropped into the system for 5 hours, and the mixture was cooled, followed by the separation and removal of the solvent. Thus, a polymer B in which the low density polyethylene reacted with a vinyl resin component was obtained. The molecular weight of polymer B was measured, and the weight average molecular weight (Mw) was 6,900 and the number average molecular weight (Mn) was 2,900. Furthermore, a dispersion obtained by dispersing the polymer in a 45-vol % aqueous solution of methanol had a transmission at a wavelength of 600 nm measured at a temperature of 25° C. of 63%.

### Production Example of Silica Fine Particles 1

In the production of silica fine particles 1, a hydrocarbon-oxygen mixing burner having a double tube structure capable of forming inner flame and outer flame was used as a combustion furnace. A two-fluid nozzle for spraying slurry is set at the center part of the burner to introduce a silicon compound as a raw material. An inflammable gas of hydrocarbon-oxygen is sprayed from the periphery of the two-fluid nozzle to form inner flame and outer flame serving as a reduction atmosphere. The amounts and the flow rates of the inflammable gas and oxygen are controlled to adjust the atmosphere, the temperature, the length of each flame, and the like. Silica fine particles are formed from the silicon compound in the flames, and are fused until the particles have the desired particle diameter. Thereafter, the particles are cooled and then collected by a bag filter or the like, whereby the silica fine particles are obtained.

Hexamethylcyclotrisiloxane was used as the silicon compound as a raw material to produce silica fine particles. 99.6% By mass of the resulting silica fine particles were surface-treated with 0.4% by mass of hexamethyldisilazane. The primary average particle diameter is summarized in Table 1.

### Production Examples of Silica Fine Particles 2 to 7

Silica fine particles 2 to 7 were prepared by the same procedure as in the case of silica fine particles 1 except that the average particle diameter of the silica raw material was changed as shown in Table 1. The primary average particle diameters, treatment agents and physical properties are summarized in Table 1.

### Production Example of Toner 1

| | |
|---|---|
| Binder resin 1 | 50.0 parts by mass |
| Binder resin 2 | 50.0 parts by mass |
| Fischer-Tropsch wax (peak temperature of maximum | 6.0 parts by mass |
| endothermic peak measured by DSC: 78° C.) | |
| C.I. Pigment Blue 15:3 | 5.0 parts by mass |
| Aluminum 3,5-di-t-butylsalicylate compound | 0.5 parts by mass |
| Polymer A | 5.0 parts by mass |

Raw materials listed in the above formulation were mixed using a Henschel mixer (FM-75 model, manufactured by Mitsui Mining Co., Ltd.) at a rotation number of 20 s⁻¹ and a rotation time of 5 min, and then the mixture was kneaded by a twin-screw kneader (PCM-30 model, manufactured by Ikegai Corporation) set at a temperature of 125° C. The resulting kneaded product was cooled, and coarsely pulverized to 1 mm or less by a hammer mill to provide a coarsely pulverized product. The resulting coarsely pulverized product was finely pulverized by a mechanical pulverizer (T-250, manufactured by Turbo Kogyo Co., Ltd.). Furthermore, a rotation type classifier (200TSP, manufactured by Hosokawa Micron Corporation) was used to perform classification to provide toner particles. The rotation type classifier (200TSP, manufactured by Hosokawa Micron Corporation) was operated under a condition of a classification rotor rotation number of 50.0 s⁻¹. The resulting toner particles had a weight average particle diameter (D4) of 5.7 μm.

To 100 parts by mass of the resulting toner particles, 4.5 parts by mass of the silica fine particles 1 were added, and the resultant was mixed by a Henschel mixer (FM-75 model, manufactured by Mitsui Mining Co., Ltd.) at a rotation number of 30 s⁻¹ and a rotation time of 10 min, and heat-treated by the surface treatment apparatus illustrated in FIG. 1. The operation conditions were as follows: amount of feed=5 kg/hr, hot air temperature C=220° C., hot air flow rate=6 m³/min, cool air temperature E=5° C., cool air flow rate=4 m³/min, cool air absolute moisture content=3 g/m³, blower air volume=20 m³/min and injection air flow rate=1 m³/min. The resultant treated toner particles had an average circularity of 0.963 and a weight average particle diameter (D4) of 6.2 μm.

To 100 parts by mass of the resultant treated toner particles, 0.5 parts of strontium titanate fine particles were added, and the resultant was mixed by a Henschel mixer (FM-75 model, manufactured by Mitsui Mining Co., Ltd.) at a rotation number of 30 s⁻¹ and a rotation time of 10 min to provide toner 1. Physical properties of the resulting toner are shown in Table 1.

### Production Examples of Toners 2 to 13

Each of toners 2 to 13 was obtained in the same manner as in Production Example of toner 1 except that the wax, the polymer, the silica fine particles, and the added number of parts of each of them were changed as shown in Table 1 and the hot air temperature was set as shown in Table 1. Physical properties of each of the resulting toners are shown in Table 1.

### Production Example of Toner 14

| | |
|---|---|
| Binder resin 1 | 50.0 parts by mass |
| Binder resin 2 | 50.0 parts by mass |
| Fischer-Tropsch wax (peak temperature of maximum | 4.0 parts by mass |
| endothermic peak measured by DSC: 78° C.) | |
| C.I. Pigment Blue 15:3 | 5.0 parts by mass |
| Aluminum 3,5-di-t-butylsalicylate compound | 0.5 parts by mass |
| Polymer B | 4.0 parts by mass |

Raw materials listed in the above formulation were mixed using a Henschel mixer (FM-75 model, manufactured by Mitsui Mining Co., Ltd.) at a rotation number of 20 s⁻¹ and a rotation time of 5 min, and then the mixture was kneaded by a twin-screw kneader (PCM-30 model, manufactured by Ikegai Corporation) set at a temperature of 125° C. The resulting kneaded product was cooled, and coarsely pulverized to 1 mm or less by a hammer mill to provide a coarsely pulverized product. The resulting coarsely pulverized product was finely pulverized by a mechanical pulverizer (T-250, manufactured by Turbo Kogyo Co., Ltd.). Furthermore, a rotation type classifier (200TSP, manufactured by Hosokawa Micron Corporation) was used to perform classification to provide toner particles. The rotation type classifier (200TSP, manufactured by Hosokawa Micron Corporation) was operated under a condition of a classification rotor rotation number of 50.0 s⁻¹. The resulting toner particles had a weight average particle diameter (D4) of 5.7 μm.

2.5 Parts by mass of the silica fine particles 5 were added thereto, and the resultant was mixed by a Henschel mixer (FM-75 model, manufactured by Mitsui Mining Co., Ltd.) at a rotation number of 30 s⁻¹ and a rotation time of 60 min to provide toner 14. Physical properties of the resulting toner are shown in Table 1.

### Production Examples of Toners 15 and 16, and Comparative Toners 17 to 22

Each of toners 15 and 16, and comparative toners 17 to 22 was obtained in the same manner as in Production Example of toner 8 except that the wax, the polymer, the silica fine particles, and the added number of parts of each of them were changed as shown in Table 1. Physical properties of each of the resulting toners are shown in Table 1.

TABLE 1

| | | Amount | | Amount | | Silica | Amount | | | Uniaxial | |
|---|---|---|---|---|---|---|---|---|---|---|---|
| | | added | | added | | particle | added | Hot air | Coverage | collapse | Sticking |
| | | (parts | | (parts | | diameter | (parts | treat- | rate | stress | ratio |
| | WAX | by mass) | Polymer | by mass) | Silica particles | (nm) | by mass) | ment | (%) | (kPa) | (%) |
| Example 1 | Fischer- | 6.0 | Polymer A | 5.0 | Silica fine particles 1 | 110 | 4.5 | 220° C. | 32% | 3.0 | 92% |
| | Tropsch | | | | | | | | | | |
| | (76° C.) | | | | | | | | | | |
| Example 2 | ↑ | 6.0 | Polymer A | 5.0 | Silica fine particles 2 | 70 | 4.0 | 220° C. | 35% | 2.9 | 94% |
| Example 3 | ↑ | 6.0 | Polymer A | 5.0 | Silica fine particles 3 | 250 | 5.0 | 220° C. | 28% | 3.1 | 89% |
| Example 4 | ↑ | 6.0 | Polymer A | 5.0 | Silica fine particles 3 | 250 | 3.5 | 220° C. | 22% | 3.2 | 90% |
| Example 5 | ↑ | 6.0 | Polymer A | 5.0 | Silica fine particles 2 | 70 | 7.0 | 220° C. | 60% | 2.9 | 88% |
| Example 6 | ↑ | 6.0 | Polymer A | 5.0 | Silica fine particles 2 | 70 | 3.5 | 220° C. | 22% | 2.7 | 90% |
| Example 7 | ↑ | 6.0 | Polymer A | 5.0 | Silica fine particles 2 | 70 | 3.5 | 240° C. | 23% | 3.3 | 91% |
| Example 8 | ↑ | 6.0 | Polymer A | 5.0 | Silica fine particles 4 | 65 | 3.0 | 200° C. | 21% | 2.7 | 90% |
| Example 9 | ↑ | 6.0 | Polymer A | 5.0 | Silica fine particles 5 | 290 | 5.5 | 220° C. | 24% | 2.8 | 88% |
| Example 10 | ↑ | 4.0 | Polymer A | 4.0 | Silica fine particles 5 | 290 | 3.5 | 180° C. | 22% | 2.5 | 87% |
| Example 11 | ↑ | 8.0 | Polymer A | 6.0 | Silica fine particles 5 | 290 | 3.5 | 240° C. | 22% | 3.5 | 90% |
| Example 12 | ↑ | 4.0 | Polymer B | 4.0 | Silica fine particles 5 | 290 | 3.5 | 160° C. | 22% | 2.5 | 85% |
| Example 13 | ↑ | 4.0 | Polymer B | 4.0 | Silica fine particles 5 | 290 | 3.0 | 150° C. | 21% | 2.5 | 81% |
| Example 14 | ↑ | 4.0 | Polymer B | 4.0 | Silica fine particles 5 | 290 | 2.5 | — | 18% | 2.6 | 67% |
| Example 15 | ↑ | 4.0 | Polymer B | 4.0 | Silica fine particles 5 | 290 | 2.0 | — | 16% | 2.6 | 69% |
| Example 16 | ↑ | 4.0 | Polymer B | 4.0 | Silica fine particles 4 | 65 | 14.0 | — | 92% | 2.5 | 72% |
| Comparative | ↑ | 4.0 | Polymer B | 4.0 | Silica fine particles 6 | 50 | 2.0 | — | 16% | 2.5 | 78% |
| Example 1 | | | | | | | | | | | |
| Comparative | ↑ | 4.0 | Polymer B | 4.0 | Silica fine particles 7 | 350 | 3.5 | — | 18% | 2.6 | 58% |
| Example 2 | | | | | | | | | | | |
| Comparative | ↑ | 4.0 | Polymer B | 4.0 | Silica fine particles 5 | 290 | 1.0 | — | 13% | 2.6 | 70% |
| Example 3 | | | | | | | | | | | |
| Comparative | ↑ | 4.0 | Polymer B | 4.0 | Silica fine particles 4 | 65 | 15.0 | — | 98% | 2.5 | 45% |
| Example 4 | | | | | | | | | | | |
| Comparative | ↑ | 3.0 | — | — | Silica fine particles 5 | 290 | 3.0 | — | 16% | 2.3 | 75% |
| Example 5 | | | | | | | | | | | |
| Comparative | ↑ | 10.0 | — | — | Silica fine particles 5 | 290 | 3.0 | — | 16% | 3.7 | 77% |
| Example 6 | | | | | | | | | | | |

### Production Example of Magnetic Carrier

<Production of Copolymer 1>

25 parts by mass of a methyl methacrylate macromer (average value n=50) having a weight average molecular weight of 5,000 with a structure represented by the following formula (3) having an ethylenic unsaturated group (methacryloyl group) at one end, and 75 parts by mass of a cyclohexyl methacrylate monomer with cyclohexyl as a unit and an ester moiety that is a structure represented by the following formula (4), were added to a four-necked flask with a reflux condenser, a thermometer, a nitrogen intake tube and a ground-in stirring apparatus. Furthermore, 90 parts by mass of toluene, 110 parts by mass of methyl ethyl ketone and 2.0 parts by mass of azobisisovaleronitrile were added thereto. The resulting mixture was held under a nitrogen stream at 70° C. for 10 hours. After the completion of a polymerization reaction, washing was repeated to provide a graft copolymer solution (solid content: 33% by mass). The weight average molecular weight of the solution by gel permeation chromatography (GPC) was 56,000. In addition, the Tg was 91° C. The resulting polymer is defined as copolymer 1.

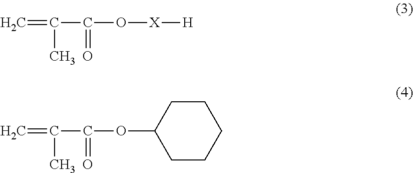

<Production of Carrier Core>

Step 1 (Weighing and Mixing Step):

| | |
|---|---|
| Fe₂O₃ | 60.2% by mass |
| MnCO₃ | 33.9% by mass |
| Mg(OH)₂ | 4.8% by mass |
| SrCO₃ | 1.1% by mass |

Ferrite raw materials were weighed so that the above formulation was achieved. Thereafter, the raw materials were pulverized and mixed by a dry ball mill using a ball made of zirconia (φ10 mm) for 2 hours.

Step 2 (Calcining Step):

After the pulverizing and mixing, the resultant was fired using a burner type firing furnace in the air at 1,000° C. for 3 hours to prepare a calcined ferrite. The composition of the ferrite was as follows.

(MnO)a(MgO)b(SrO)c(Fe₂O₃)d

wherein a=0.39, b=0.11, c=0.01 and d=0.50.

Step 3 (Pulverizing Step):

The resultant was pulverized to about 0.5 mm by a crusher, thereafter 30 parts by mass of water were added to 100 parts by mass of the calcined ferrite, and the resultant was pulverized by a wet ball mill for 2 hours using a ball made of zirconia (φ10 mm). The slurry was pulverized by a wet bead mill using beads (φ1.0 mm) made of zirconia for 4 hours to provide a ferrite slurry.

Step 4 (Granulating Step):

As a binder, 2.0 parts by mass of polyvinyl alcohol was added to the ferrite slurry with respect to 100 parts by mass of the calcined ferrite, and the resultant was granulated into spherical particles having a diameter of about 36 μm by a spray dryer (manufacturer: Ohkawara Kakohki Co., Ltd.).

Step 5 (Main Firing Step):

In order to control a firing atmosphere, the resultant was fired in an electric furnace under a nitrogen atmosphere (oxygen concentration: 1.00% by volume or less) at 1,150° C. for 4 hours.

Step 6 (Screening Step):

After the aggregated particles were crushed, coarse particles were removed by sieving with a sieve having a mesh of 250 μm to provide magnetic core particles.

### Production Example of Magnetic Carrier 1

Copolymer 1 was dissolved in toluene so that the solid content was 10% by mass. Carbon black (#25 produced by Mitsubishi Chemical Corporation) was added therein in an amount of 5 parts by mass with respect to 100 parts by mass of the solid content of a covering resin, and the resultant was sufficiently stirred and dispersed.

Then, a universal mixing stirrer (manufactured by Fuji Paudal Co., Ltd.) was used as a coating apparatus, and a coating solution was charged thereto in three portions so that the amount of the covering resin (as the solid content) was 1.5 parts by mass with respect to 100 parts by mass of the carrier core. In the case, the inside of the mixing stirrer was depressurized, and nitrogen was introduced thereto to replace the atmosphere with nitrogen. The resulting mixture was heated to a temperature of 65° C., and stirred while being kept the reduced pressure (700 MPa) in a nitrogen atmosphere, and the solvent was removed until the carrier was free-flowing. The resultant was further heated to a temperature of 100° C. with stirring and nitrogen-introducing, and held for 1 hour. After cooling, magnetic carrier 1 was obtained.

### Example 1

The toner 1 and the magnetic carrier 1 were mixed by a V-type mixer (V-10 model: manufactured by Tokuju Corporation) at 0.5 s⁻¹ and at a rotation time of 5 min so that the toner concentration was 9% by mass. Thus, two-component developer 1 was obtained. Two-component developer 1 was used to perform evaluations described below. The results were shown in Table 3.

(Evaluation 1) Evaluation Method of Transferability

As the image forming apparatus, a full-color copier, altered imageRUNNER ADVANCE C5255 manufactured by Canon Inc., was used. After an endurance image output test under a high-temperature and high-humidity environment (30° C./80% RH) and under a low-temperature and low-humidity environment (10° C./15% RH) for 50,000 sheets, a solid image was output. The transfer residual toner on the photosensitive member drum during solid image formation was peeled by taping with a transparent polyester adhesive tape. The adhesive tape used for peeling was pasted on paper, and the image density thereof was measured by spectral densitometer 500 series (X-Rite, Inc.). In addition, only an adhesive tape was pasted on paper and the image density in the case was also measured. The difference in image density, as a value obtained by subtracting the latter image density from the former image density, was calculated, and evaluated with respect to the evaluation criteria below.

During a continuous paper-feeding time for 50,000 sheets, paper-feeding is performed under the same developing condition and the same transfer condition (no calibration) as in the case of the first sheet. With respect to evaluation paper, plain paper CS-680 for coping (A4, basis weight: 68 g/m², sold by Canon Marketing Japan Inc.) was used for the endurance image output for 50,000 sheets, and for the solid image after the output test, copier paper Multi-Purpose Paper: popular name Voice Paper (A4, basis weight: 75 g/m², sold by Canon USA, Inc.) was used in addition to plain paper CS-680 for coping.

(Evaluation Criteria of Transferability)

A: Very good (the difference in image density was less than 0.05)
B: Good (the difference in image density was 0.05 or more and less than 0.10)
C: Normal (the difference in image density was 0.10 or more and less than 0.15)
D: Slightly poor (the difference in image density was 0.15 or more and less than 0.20)
E: Poor (the difference in image density was 0.20 or more)

(Evaluation 2) Evaluation Method of Cleaning

After an endurance image output test under a high-temperature and high-humidity environment (30° C./80% RH) for 50,000 sheets, an image having an image area ratio of 10% was further output for 1,000 sheets. As evaluation paper, plain paper CS-680 for coping (A4, basis weight: 68 g/m², sold by Canon Marketing Japan Inc.) was used. In the image after outputting for 1,000 sheets, generation of a vertical streak image due to the toner that remained without being cleaned was observed, and evaluated with respect to the evaluation criteria below.

(Evaluation Criteria of Cleanability)

A: Very good (no vertical streak image was generated.)
B: Good (2 to 3 slight vertical streak patterns were generated.)
C: Normal (some slight vertical streak patterns were generated.)
D: Slightly Poor (some wide vertical streak patterns were generated.)
E: Poor (a large number of wide vertical streak patterns were generated.)

### Examples 2 to 16

Each of two-component developers was obtained in the same manner as in Example 1 except that the toner was changed as shown in Table 2. The evaluation was performed in the same manner as in Example 1, and the results were shown in Table 3.

### Comparative Examples 1 to 6

Each of two-component developers was obtained in the same manner as in Example 1 except that the toner was changed as shown in Table 2. The evaluation was performed in the same manner as in Example 1, and the results were shown in Table 3.

TABLE 2

| | Toner No. | Carrier No. | Two-component developer No. |
|---|---|---|---|
| Example 1 | Toner 1 | Carrier 1 | Two-component developer 1 |
| Example 2 | Toner 2 | Carrier 1 | Two-component developer 2 |
| Example 3 | Toner 3 | Carrier 1 | Two-component developer 3 |
| Example 4 | Toner 4 | Carrier 1 | Two-component developer 4 |
| Example 5 | Toner 5 | Carrier 1 | Two-component developer 5 |
| Example 6 | Toner 6 | Carrier 1 | Two-component developer 6 |
| Example 7 | Toner 7 | Carrier 1 | Two-component developer 7 |
| Example 8 | Toner 8 | Carrier 1 | Two-component developer 8 |
| Example 9 | Toner 9 | Carrier 1 | Two-component developer 9 |
| Example 10 | Toner 10 | Carrier 1 | Two-component developer 10 |
| Example 11 | Toner 11 | Carrier 1 | Two-component developer 11 |
| Example 12 | Toner 12 | Carrier 1 | Two-component developer 12 |
| Example 13 | Toner 13 | Carrier 1 | Two-component developer 13 |
| Example 14 | Toner 14 | Carrier 1 | Two-component developer 14 |
| Example 15 | Toner 15 | Carrier 1 | Two-component developer 15 |
| Example 16 | Toner 16 | Carrier 1 | Two-component developer 16 |
| Comparative | Toner 17 | Carrier 1 | Two-component developer 17 |
| Example 1 | | | |
| Comparative | Toner 18 | Carrier 1 | Two-component developer 18 |
| Example 2 | | | |
| Comparative | Toner 19 | Carrier 1 | Two-component developer 19 |
| Example 3 | | | |
| Comparative | Toner 20 | Carrier 1 | Two-component developer 20 |
| Example 4 | | | |
| Comparative | Toner 21 | Carrier 1 | Two-component developer 21 |
| Example 5 | | | |
| Comparative | Toner 22 | Carrier 1 | Two-component developer 22 |
| Example 6 | | | |

TABLE 3

| | Difference in transferability density | | | | | | | | |
|---|---|---|---|---|---|---|---|---|---|
| | Plain paper (smoothness: 45 seconds) | | | | Voice Paper (smoothness: 25 seconds) | | | | |
| | HH | Rank | LL | Rank | HH | Rank | LL | Rank | Cleanability |
| Example 1 | 0.01 | A | 0.01 | A | 0.02 | A | 0.01 | A | A |
| Example 2 | 0.01 | A | 0.01 | A | 0.03 | A | 0.03 | A | A |
| Example 3 | 0.02 | A | 0.01 | A | 0.03 | A | 0.03 | A | A |
| Example 4 | 0.02 | A | 0.02 | A | 0.05 | B | 0.04 | A | A |
| Example 5 | 0.01 | A | 0.01 | A | 0.03 | A | 0.03 | A | B |
| Example 6 | 0.03 | A | 0.02 | A | 0.05 | B | 0.04 | A | A |
| Example 7 | 0.03 | A | 0.03 | A | 0.05 | B | 0.03 | A | A |
| Example 8 | 0.03 | A | 0.03 | A | 0.05 | B | 0.03 | A | A |
| Example 9 | 0.04 | A | 0.03 | A | 0.05 | B | 0.04 | A | A |
| Example 10 | 0.04 | A | 0.03 | A | 0.05 | B | 0.04 | A | B |
| Example 11 | 0.05 | B | 0.04 | A | 0.07 | B | 0.06 | B | A |
| Example 12 | 0.06 | B | 0.04 | A | 0.07 | B | 0.07 | B | A |
| Example 13 | 0.06 | B | 0.04 | A | 0.08 | B | 0.07 | B | B |
| Example 14 | 0.08 | B | 0.07 | B | 0.09 | B | 0.08 | B | B |
| Example 15 | 0.08 | B | 0.07 | B | 0.09 | B | 0.09 | B | B |
| Example 16 | 0.07 | B | 0.06 | B | 0.08 | B | 0.08 | B | B |
| Comparative | 0.07 | B | 0.07 | B | 0.10 | C | 0.09 | B | B |
| Example 1 | | | | | | | | | |
| Comparative | 0.08 | B | 0.07 | B | 0.10 | C | 0.09 | B | B |
| Example 2 | | | | | | | | | |
| Comparative | 0.10 | C | 0.09 | B | 0.12 | C | 0.11 | C | B |
| Example 3 | | | | | | | | | |
| Comparative | 0.10 | C | 0.09 | B | 0.11 | C | 0.10 | C | B |
| Example 4 | | | | | | | | | |
| Comparative | 0.06 | B | 0.06 | B | 0.13 | B | 0.08 | B | C |
| Example 5 | | | | | | | | | |
| Comparative | 0.12 | C | 0.10 | B | 0.14 | C | 0.12 | C | B |
| Example 6 | | | | | | | | | |

The Comparative Examples did not achieve sufficient effects as compared with the Examples according to the present invention, and the reason for this is considered as follows.

In Comparative Example 1, the silica fine particles having a number-average particle diameter of primary particles of 50 nm are used. It is therefore considered that since releasability with the transfer member was not sufficient, the effect of the present invention was not achieved.

In Comparative Example 2, the silica fine particles having a number-average particle diameter of primary particles of 350 nm are used. It is therefore considered that since the coverage rate of the surfaces of the toner particles with the silica fine particles was low and releasability with the transfer member was not sufficient, the effect of the present invention was not achieved.

In Comparative Example 3, the toner having a low coverage rate of the surfaces of the toner particles with the silica fine particles is used. It is therefore considered that since releasability with the transfer member was not sufficient, the effect of the present invention was not achieved.

In Comparative Example 4, the added number of parts of the silica fine particles is high and the toner having a high coverage rate of the surfaces of the toner particles with the silica fine particles is used. It is therefore considered that since the uniaxial collapse stress between the toners was low to cause cleaning failures, and the silica fine particles had a low sticking ratio and releasability thereof with the intermediate transfer material after endurance was not sufficient, the effect of the present invention was not achieved.

In Comparative Example 5, the toner having a small number of parts of the wax and having a low sticking ratio of the silica fine particles is used. It is therefore considered that since the uniaxial collapse stress between the toners was low and releasability with the intermediate transfer material after endurance was not sufficient, the effect of the present invention was not achieved.

In Comparative Example 6, the toner having a large number of parts of the wax and including no polymer is used. It is therefore considered that since the uniaxial collapse stress between the toners was too high, the effect of the present invention was not achieved.

While the present invention has been described with respect to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-096481, filed May 1, 2013, which is hereby incorporated by reference herein in its entirety.

What is claimed is:

1. A toner, comprising:
toner particles each containing a binder resin and a wax; and
silica fine particles on surfaces of the toner particles, wherein:
the silica fine particles have a number-average particle diameter of primary particles of 60 nm or more and 300 nm or less;
a coverage rate of the surfaces of the toner particles with the silica fine particles is 15% or more and 95% or less; and
the toner has a uniaxial collapse stress at a maximum consolidation stress of 10.0 kPa, of 2.5 kPa or more and 3.5 kPa or less.

2. The toner according to claim 1, wherein the toner has a sticking ratio of the silica fine particles of 80% by mass or more with respect to a total amount of the silica fine particles.

3. The toner according to claim 1, wherein the coverage rate of the surfaces of the toner particles with the silica fine particles is 20% or more and 95% or less.

4. The toner according to claim 1, wherein the toner particles contain a polymer having a structure in which a vinyl-based resin component and a hydrocarbon compound react with each other.

5. The toner according to claim 4, wherein the polymer comprises one of
a graft polymer having a vinyl-based resin component as a main chain and having a polyolefin as a side chain, and
a graft polymer having a polyolefin as a main chain and having a vinyl-based resin component as a side chain.

6. The toner according to claim 4, wherein the polymer having a structure in which a vinyl-based resin component and a hydrocarbon compound react with each other is contained in an amount of 0.2 parts by mass or more and 20 parts by mass or less with respect to 100 parts by mass of the binder resin.

7. The toner according to claim 1, wherein the binder resin comprises a polyester resin having an acid value of 1 mg KOH/g or more and 20 mg KOH/g or less.

8. The toner according to claim 1, wherein a content of the wax is 0.5 parts by mass or more and 20 parts by mass or less with respect to 100 parts by mass of the binder resin.

9. The toner according to claim 1, wherein the silica fine particles are subjected to surface treatment with one of a silane coupling agent and a silicone oil.

10. The toner according to claim 9, wherein the silica fine particles are subjected to surface treatment with hexamethyldisilazane.

11. An image forming method, comprising:
charging a surface of a photosensitive member;
forming an electrostatic latent image on the photosensitive member by light exposure;
developing the electrostatic latent image by a toner to form a toner image;
primarily transferring the toner image to an intermediate transfer member and then secondarily transferring the toner image on the intermediate transfer member to a transfer material; and
removing a transfer residue toner remaining on the intermediate transfer member after the primary transferring, from the intermediate transfer member by a cleaning member, wherein:
the toner comprises toner particles each containing a binder resin and a wax, and silica fine particles on surfaces of the toner particles;
the silica fine particles have a number-average particle diameter of primary particles of 60 nm or more and 300 nm or less;
a coverage rate of the surfaces of the toner particles with the silica fine particles is 15% or more and 95% or less; and
the toner has a uniaxial collapse stress at a maximum consolidation stress of 10.0 kPa, of 2.5 kPa or more and 3.5 kPa or less.
